(19) United States
(12) Patent Application Publication
(10) Pub. No.: US 2013/0120960 A1
(43) Pub. Date: May 16, 2013

(54) Apparatus to provide a multi-purpose reflective umbrella and lighting enhancement device for the purposes of providing illumination during still, motion, and video photography.

(71) Applicant: Hooshmand Harooni, (US)

(72) Inventor: Hooshmand Harooni, (US)

(21) Appl. No.: 13/295,766

(22) Filed: Nov. 14, 2011

(51) Int. Cl. G03B 15/06; F21V 21/40

(52) U.S. Cl. 362/16; 362/433

(57) ABSTRACT

This invention relates to a new apparatus devised to deliver a multi-purpose reflective umbrella and lighting enhancement device for the purposes of providing illumination during still, motion, and video photography (hereinafter known as “multi-purpose umbrella apparatus”). More specifically, this invention provides the ability to have a single device deliver both the reflective and light bounce properties normally found in multiple devices.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

This invention relates to a new apparatus devised to deliver a multi-purpose reflective umbrella and lighting enhancement device for the purposes of effecting illumination during still, motion, and video photography (hereinafter known as “multi-purpose umbrella apparatus”). More specifically, this invention provides the ability to have a single device deliver both the reflective and light bounce properties normally found in multiple devices.

The proper and clever use of lighting in still, motion, and video photography can often be the deciding factor between an unacceptable and spectacular result. The use of color, direction, quality, and quantity of light determines the appearance of the subject or item that is being photographed. Reflective surfaces are used outdoors and indoors to control shadows and contrast. Umbrellas and other surfaces are used to provide bounced strobed and non-strobed artificial lighting by “bouncing” off of the inside surface of an umbrella device. Today, photographers and videographers must purchase separate devices to meet each of these specific lighting needs and techniques. Also, switching between one type of reflective surface and another often requires the disassembly and reassembly of each device.

Accordingly, it would be highly desirable to have a single, multi-purpose device that could meet multiple or all of these lighting needs in a single photography accessory apparatus.

### SUMMARY OF THE INVENTION

In view of the foregoing, this patent application provides a completely integrated, multi-purpose umbrella solution to meet multiple photography and videography lighting needs. The apparatus described in this application is a reflective umbrella-shaped lighting device that has the following properties.

Users of this umbrella apparatus will be able to use the device in a lighting bounce back mode where the inside of the umbrella is pointed away from the subject or item in a photography or videography session, and where the lighting source (strobed or non-strobed) is attached to the interior shaft of the umbrella and pointed towards the inside of the umbrella. In this mode the umbrella apparatus bounces the light source from the inside of the umbrella back to the subject or item, and depending on the color of the inside surface affects the contrast, shadows, and softness of the result.

Users of this umbrella apparatus will be able to attach the shaft of the device on the outside surface of the umbrella to a standard photography or videography tripod or c-stand, with or without removing the longer portion of the shaft on the inside of the umbrella. With the longer portion of the shaft still attached, the umbrella apparatus can be used as a stationary lighting bounce back device, with the inside surface of the umbrella pointed towards the subject or target of the photography or videography session to control the contrast, shadow, and softness from the lighting source. While attached to the tripod or c-stand, the angle of the umbrella can be locked into a desired position by utilizing a lock lever on the standard photographic stand mount at the bottom of the grip, which in turn is attached to the outside shaft of the umbrella apparatus.

With the inside longer shaft removed, the umbrella apparatus can be used as a stationary reflective device. In this latter mode the multi-purpose umbrella apparatus can continue to be attached in one of multiple locked positions at different angles to the tripod or c-stand, utilizing the same lock lever device explained in the previous paragraph. The inside surface is then pointed towards the subject or target of the photography or videography session to control the diffusion and softness of a lighting source, whether that lighting source be artificial, natural, or ambient.

Users of this umbrella apparatus, finally, will also be able to detach the grip accessory from the tripod or c-stand while it is still attached to the outside shaft of the umbrella. In this mode, the inside surface of the umbrella can still be used as a hand held reflective device, thereby providing maximum portability for the photography or videography session.

Therefore, with the multi-purpose umbrella apparatus described in this document, a single apparatus can be used as a reflective or lighting bounce back photography/videography accessory, and can be used in a fixed or hand held mode to provide maximum flexibility.

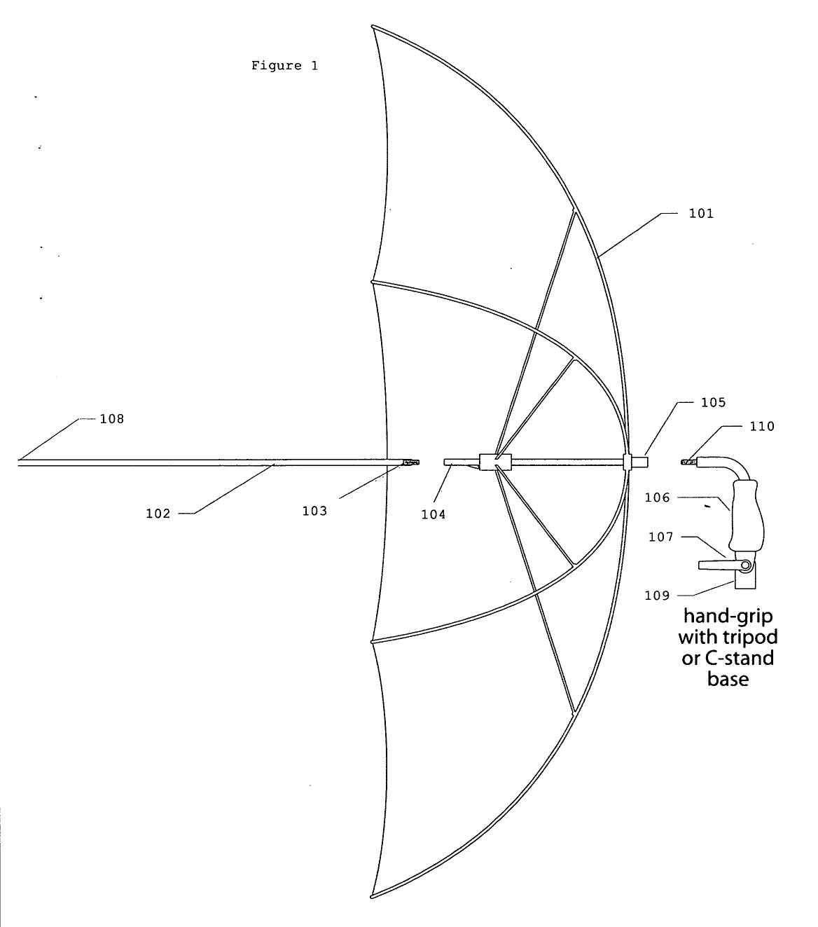

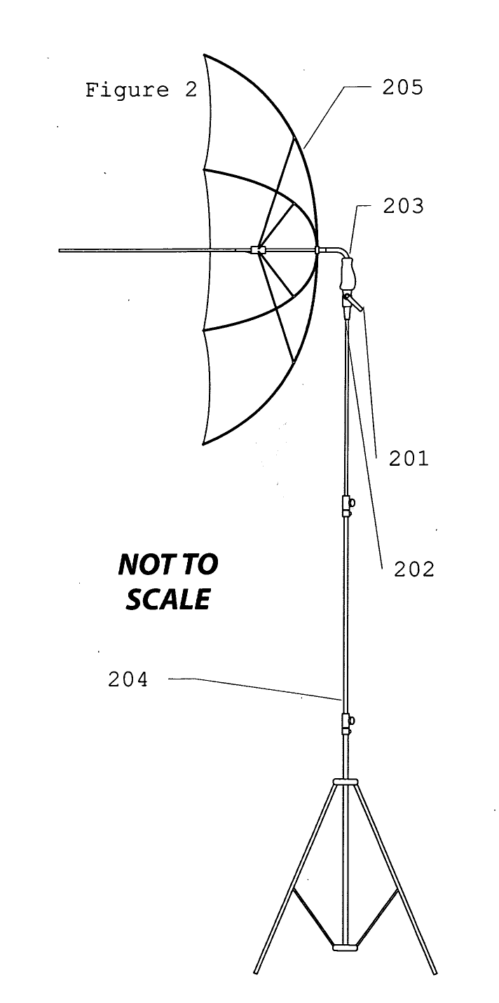

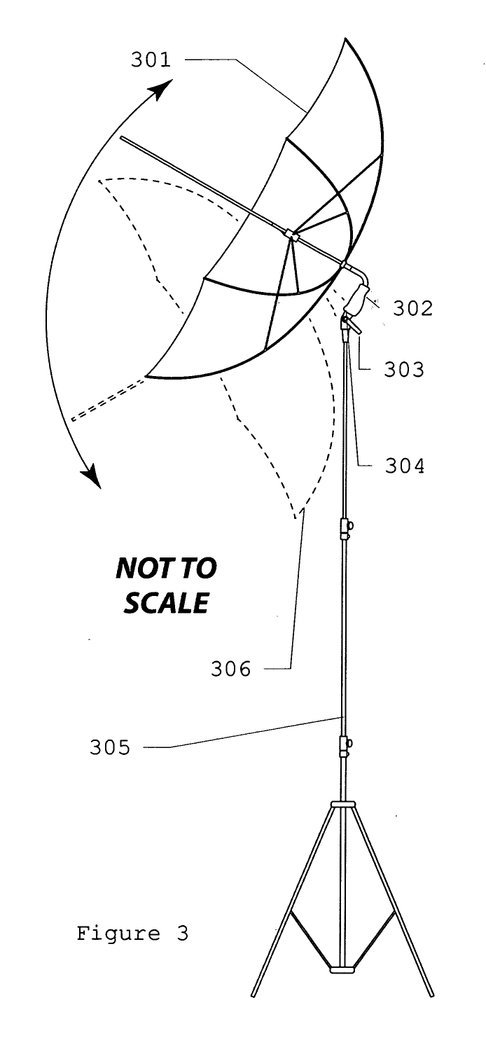

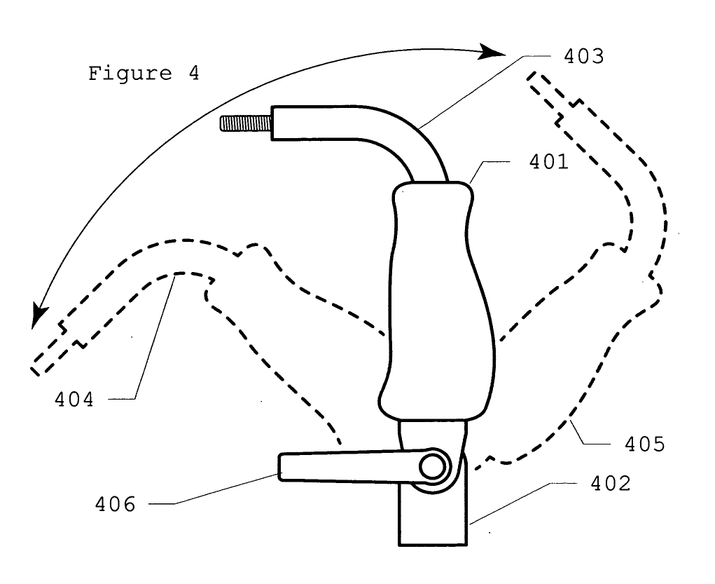

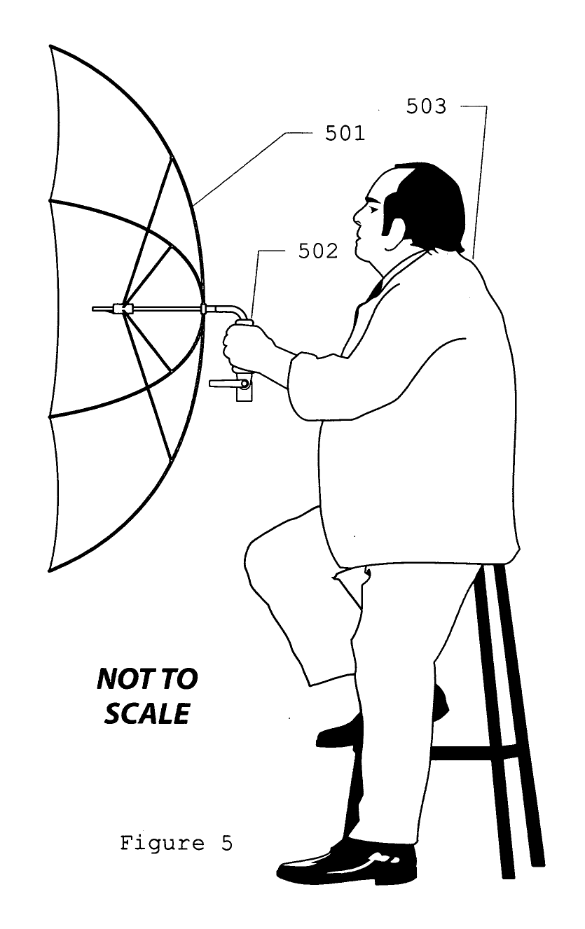

### BRIEF DESCRIPTION OF THE DRAWINGS

<FIG. 1> Diagram showing multi-purpose umbrella apparatus, showing detachable inside shaft and detachable hand-grip.

<FIG. 2> Diagram showing multi-purpose umbrella apparatus attached to tripod or c-stand utilizing standard photographic stand mount

<FIG. 3> Diagram showing multi-purpose umbrella apparatus locked in different positions utilizing the standard photographic stand mount.

<FIG. 4> Close up diagram showing the hand-held grip and standard photographic stand mount assembly with lock lever mechanism of the multi-purpose umbrella device.

<FIG. 5> Diagram showing multi-purpose umbrella apparatus in a hand held position utilizing the hand grip assembly.

### DETAILED DESCRIPTION OF THE INVENTION

The multi-purpose reflective umbrella apparatus described in this application provides the following components. An umbrella apparatus to be utilized for the purposes of controlling natural, ambient, and artificial lighting sources in the production of still, motion, and video photography. The inside surface of the umbrella apparatus will be made from a reflective surface available in several colors. The design of the umbrella apparatus will be such that it will be capable of being manufactured in a variety of standard photography and videography sizes, from 30 inches to 60 inches, with the diameter measured across the umbrella spokes. The inside shaft of the umbrella will be detachable from the base of the umbrella apparatus. Attached to the outside shaft of the umbrella will be a multi-purpose hand held grip with a standard photographic standard accessory allowing the apparatus to be attached to a standard fixed tripod or c-stand device used in the photography/videography industries and also to be hand held by photographer or videographer and utilized as a reflective surface device. Using this methodology, the multi-purpose reflective umbrella apparatus can be used for different purposes as a reflective surface and a bounce back device, providing capabilities in a single apparatus that are currently served in the photography and videography markets by multiple devices.

<FIG. 1> shows the umbrella apparatus and all of its components. 101 depicts the base umbrella device, comprised usually of a steel or metal (although could be plastic) frame with a reflective surface material stretched on the inside surface. 102 depicts the long shaft of the multi-purpose umbrella apparatus. 102 is detachable from the main umbrella device 101 using a male screw-in surface 103 coupled and detachable from main umbrella using female screw-in receptacle 104. When the multi-purpose umbrella apparatus is used in a bounce back mode, with the long shaft 102 still attached to main umbrella device 101, lighting devices can be attached to the shaft at point 108 utilizing a standard umbrella holder comprised as part of the lighting device being attached to.

<FIG. 1> also shows the option of main umbrella base device 101 being attached to a hand grip 106 utilizing the mail screw-in surface 110 attached to female screw-in receptacle 105. The bottom portion of hand grip accessory 106 connects to a standard photographic stand mount at 109, which can be locked to a photography or videography tripod or c-stand utilizing a pressure loaded locking lever device 107.

<FIG. 2> shows the main umbrella base device 205 attached to a tripod or c-stand 204 in a permanent, locked position. The umbrella base is shown attached to the tripod or c-stand 204 utilizing the hand grip 203 attached to standard photographic stand mount 202, and locked into position using lock lever 201. The hand grip 203 is permanently attached to the photographic stand mount 202 as part of a single, integrated accessory device to the base umbrella apparatus.

<FIG. 3> shows the multi-purpose umbrella device, again attached to a photographic tripod or c-stand 305 utilizing the hand grip/stand mount combination 302/304, and locked into position utilizing lock lever 303. The solid line outline of base umbrella device 301 shows the multi-purpose umbrella locked into one position, and the dotted line outline of the base umbrella device in 306 depicts that multi-purpose umbrella locked into another position. An entire 270 degree range of motion is possible using the standard photographic stand mount 304 including from the straight up vertical mode to the straight down vertical mode, and an additional 45 degrees in either direction past the straight up and straight up modes in the opposite direction of what is shown in FIG. 3.

<FIG. 4> shows a close-up of the hand grip and stand mount assembly. The base hand grip portion is shown in 401, and in the hand held mode is used by a photographer or videographer to be held at an angle of their choosing. The based hand grip 401 is attached to a small shaft 403 that terminates in a male screw-in surface that can be used to attach to the base umbrella device 301. 402 shows the standard photographic stand mount that is used to attach to a photographic tripod or c-stand device. The solid outline of the hand grip and stand mount accessory 401 shows the accessory in the full vertical position. The dotted line outlines 404 and 405 of the hand grip and stand mount accessory show alternate positions of the accessory into which positions the accessory can be locked utilizing lock lever 406.

<FIG. 5> shows the multi-purpose umbrella apparatus in a complete, free form, hand held mode. The base umbrella device 501 is attached to hand grip and stand mount accessory 502, and being held by the photographer or videographer represented by 503.

What is claimed is:

1. A unique multi-purpose umbrella apparatus used as an lighting accessory in the photography and videography markets that can be utilized both as a reflective light surface and a bounce back light surface.

2. A self-contained hand held grip and stand mount attachment that allows the multi-purpose umbrella apparatus to be used in both a tripod or photographic c-stand mounted, fixed mode and/or a hand-held mode.
